(19) United States
(12) Patent Application Publication
(10) Pub. No.: US 2008/0043474 A1
(43) Pub. Date: Feb. 21, 2008

(54) Illuminable novelty device

(76) Inventor: David Andrew Reetz, Plymouth, MN (US)

Correspondence Address: Lee Pederson, 4610 Cascade Lane, Edina, MN, 55436, US

(21) Appl. No.: 11/818,117

(22) Filed: Jun. 13, 2007

Related U.S. Application Data
(60) Provisional application No. 60/814,168, filed on Jun. 16, 2006.

(51) Int. Cl. F21V 23/04; F21V 3/02

(52) U.S. Cl. 362/295; 362/311

(57) ABSTRACT

An illuminable novelty device comprises an outer casing, inner unit, LED, circuit board, battery, bottom lid, and filler. The inner unit is fitted in the outer casing and comprises a base and an opening for the LED into the outer casing. The LED is fitted into the opening of the inner unit and the circuit board is under the LED, and the battery is under the circuit board. The bottom lid is at the bottom of the outer casing and has a push-button switch.

### RELATED APPLICATIONS

This application claims priority based on U.S. Provisional Patent Application Ser. No. 60/814,168 entitled “Illuminable Novelty Device”, filed Jun. 16, 2006, in the name of the same inventor and commonly owned herewith.

### FIELD OF THE INVENTION

This invention involves an illuminable novelty device.

### BACKGROUND OF INVENTION

Illuminable novelty devices often have filler material. One purpose of the filler material may be to refract and disperse light from a light source. It has been a continuing problem to find filler materials that are safe, durable and that possess desirable light refraction and dispersal properties.

### BRIEF DESCRIPTION OF THE INVENTION

An illuminable novelty device comprises an outer casing, inner unit, LED, circuit board, battery, bottom lid, and filler. The inner unit is fitted in the outer casing and comprises a base and an opening for the LED into the outer casing. The LED is fitted into the opening of the inner unit and the circuit board is under the LED, and the battery is under the circuit board. The bottom lid is at the bottom of the outer casing and has a push-button switch.

### BRIEF DESCRIPTION OF DRAWINGS

In the drawings:

FIG. 1 is a sketch of an illuminable cube;

FIG. 2 is an exploded 3-D view of this invention;

FIG. 3 is the front view of front view of the bottom lid;

FIG. 4 is the back view of front view of the bottom lid;

FIG. 5 is a 3-D view of a filler shape;

FIG. 6 is a 3-D view of a filler shape;

FIG. 7 is a 3-D view of a filler shape;

FIG. 8 is a 3-D view of a filler shape.

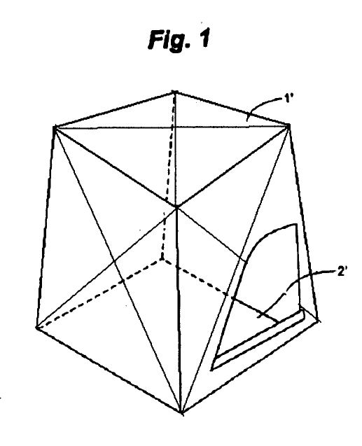

### DETAILED DESCRIPTION OF PREFERRED EMBODIMENTS

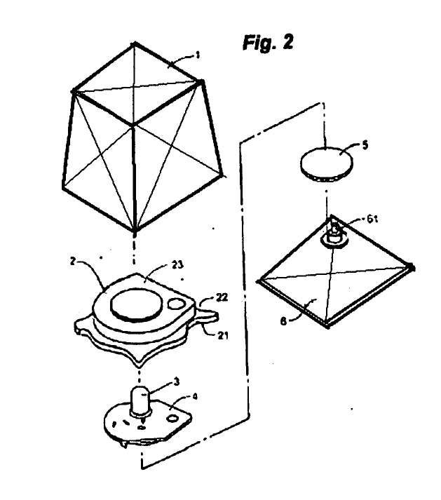

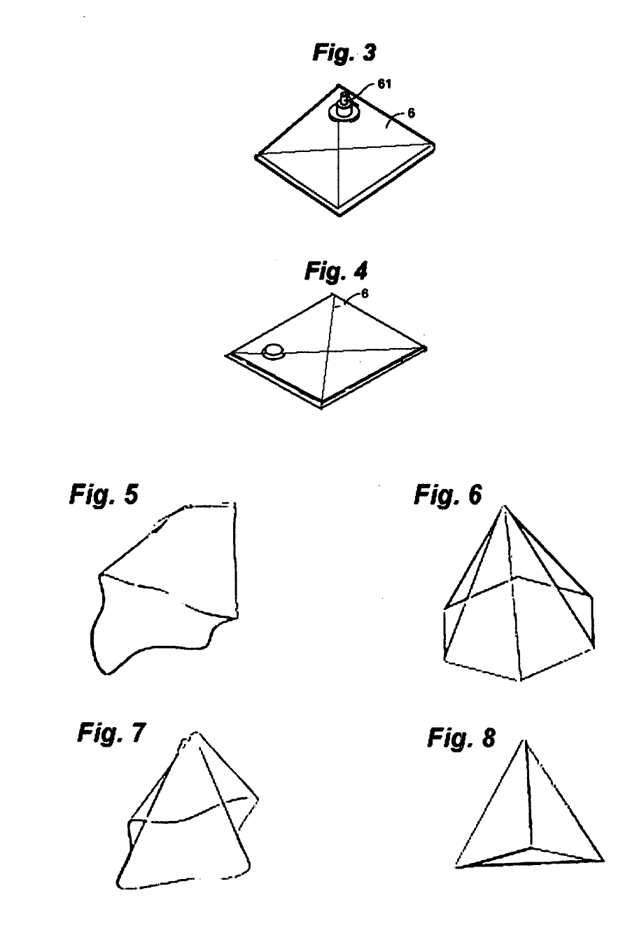

As in FIG. 2, the illuminable electronic device comprises an outer casing 1, optional inner unit 2, light source (optionally a LED) 3, circuit board 4, power source (optionally a battery) 5, bottom lid 6. The optional inner unit when provided is fitted into the outer casing, it comprises the base 21, raised and optional support 22, and an opening (optionally a circular opening) 23. The LED 3 extended through the opening of the inner unit 23, protruding into the cavity of the outer casing 1. The illustrated circuit board 4 is connected to the LED 3. The illustrated battery 5 is installed below the circuit board 4. The bottom lid 6 is at a bottom side of the outer casing 1. An optional push button switch 61 is on the bottom lid 6. As shown in FIG. 3, the push button switch 61 is mounted on the lid 6. Small particles of filler as shown in FIG. 5 through FIG. 8 are placed in the cavity of outer casing 1.

The outer casing 1 preferably comprises (i.e., is optionally formed of) polypropylene. The filler is generally small particles (optionally polypropylene). The inner unit 2 can optionally be made of PERSPEX synthetic resins.

When assembling, place filler into cavity of outer casing 1. Then place the light source 3, circuit board 4, and power source 5 into the opening 23 of the inner unit. The bottom lid 6 is then sonically welded to the outer casing 1.

The filler material used in the present invention comprises pieces of clear or translucent filler (optionally polypropylene). The filler may be colorless, or it may include a colored dye. The pieces are sized to weigh between about 0.07 and 0.13 grams each. The pieces may be geometric shapes or simple irregular shapes. However, the pieces should generally be compact so that they tumble freely. Pieces that are elongate, or pieces that may become entangled with other pieces, are less desirable.

Polypropylene has been determined to be an advantageous filler material. One advantage of polypropylene is that it does not melt, as some previous filler materials have been known to do. Another is that it is safe to use in contact with food and beverage. A third advantage is that its refractive properties are well suited to this type of illuminable novelty device, especially when the pieces are sized and shaped as described herein. Pyramid-shaped pieces have been found to result in a surprising light dispersion.

The filler pieces are preferably included in the inner cavity of the device along with a light source. Interactions between the light source and the filler pieces determine the overall effect of the device. In some embodiments, at least part of the light source (e.g., at least part of the LED) is in communication (i.e., comes in direct contact with) the filler particles.

In one aspect, the invention comprises an illuminable electronic device having an outer casing comprising a desired material and bounding a cavity. The casing material is transparent or translucent. The device has an inner unit adapted for carrying a light source and a battery and filler within the cavity. The filler comprises particles of the desired material. The filler pieces may be generally pyramid shaped. The device may have a major dimension of less than 5 inches. The outer casing and filler particles may be polypropylene. The outer casing may be assembled together with a lid such that the assembled lid and outer casing together define a six-wall cube shape wherein each wall has an outwardly protuberant configuration. Each wall may have a faceted outwardly protuberant configuration. Each wall may protrude outwardly to an apex, rather than having a planar surface. Each apex may be located at a wall midpoint. The light source may be in direct communication with the filler particles.

In another aspect, the invention comprises an illuminable electronic device having an outer casing comprising a desired material, an inner unit positioned within the outer casing where the inner unit comprises a base, an LED positioned within the outer casing, a battery positioned in the inner unit, a bottom lid positioned at a bottom of the outer casing, and a filler within the cavity comprised of the desired material. The filler pieces may be generally pyramid shaped.

In another aspect, the invention comprises an illuminable electronic device having an outer casing bounding a cavity. An inner unit is positioned within the outer casing, the inner unit comprising a base and defining an opening into the cavity, an LED positioned within the outer casing, wherein a printed circuit board is disposed within the inner unit, wherein wires extend from the printed circuit board through said opening into the cavity and to the LED, a battery positioned in the inner unit, and a bottom lid positioned at a bottom of the outer casing, the bottom lid further comprising a push button switch. Filler particles are dispersed in the cavity. The filler pieces are generally pyramid shaped particles.

In yet another aspect, the invention comprises an illuminable electronic device having an outer casing and a bottom lid, such casing and lid surrounding a inner cavity, an inner unit disposed within the cavity, such inner unit containing a power source, and filler particles disposed within the inner cavity, where the filler particles comprise polypropylene. Preferably the filler particles each weigh between about 0.07 and 0.13 grams. Preferably the filler particles are geometric shapes, irregular shapes, or are generally pyramid-shaped. The device may be at least generally cube-shaped, where the outer edges of the device are between about 25 and 35 mm in length, and where the inner cavity contains between about 75 and 125 pieces of filler material.

In one embodiment, the invention comprises an illuminable electronic device having an outer casing and a bottom lid, such casing and lid surrounding (i.e., defining) an inner cavity; a light source disposed within the inner cavity; and filler particles disposed within the inner cavity, where the filler particles comprise pieces of polypropylene. The pieces of polypropylene each weigh between about 0.07 and 0.13 grams. The pieces of polypropylene may be geometric shapes, irregular shapes, pyramid shapes, or any combination thereof. The device is essentially cube-shaped, the outer edges of the cube are between about 25 and 35 mm in length, the edges of the inner cavity are between about 20 and 30 mm in length, and the inner cavity contains between about 75 and 125 pieces of filler material. The outer walls of the device may be faceted, and the facets may protrude to apexes.

In another embodiment, the invention comprises an illuminable electronic device having an outer casing and a bottom lid, such casing and lid surrounding (i.e., defining) an inner cavity; an inner unit disposed within the inner cavity, a battery and a light source within the inner cavity; and filler particles disposed within the inner cavity, where the filler particles comprise pieces of polypropylene. The pieces of polypropylene each weigh between about 0.07 and 0.13 grams. The pieces of polypropylene may be geometric shapes, irregular shapes, pyramid shapes, or any combination thereof. The device is essentially cube-shaped, the outer edges of the cube are between about 25 and 35 mm in length, the edges of the inner cavity are between about 20 and 30 mm in length, and the inner cavity contains between about 75 and 125 pieces of filler material.

In a currently preferred embodiment, the invention comprises an illuminable electronic device having a transparent or translucent outer casing bounding a cavity, where the casing is generally cube-shaped and the outer edges are between about 25 and 35 mm in length; a lid keeping the cavity watertight; a light source within the cavity; and a filler within the cavity; the filler being comprised of between about 25 and 200 plastic particles. The casing is essentially comprised of polypropylene. Each wall of the casing has a faceted outwardly protuberant configuration. The device may further include an inner unit, where the inner unit supports the light source and is attached to a power source. The inner unit includes a printed circuit board. The lid includes a switch. The light is an LED. The particles are geometrically shaped, and are preferably pyramid shaped. The particles are comprised of polypropylene. The device preferably includes between about 75 and 125 particles and the particles weigh between about 0.07 and 0.13 grams each.

While LEDs are a preferred light source for use in this invention, those of skill in the art will recognize that the invention may be practiced with other types of light sources. Similarly, those of skill in the art will recognize that switches other than push-button switches may be used.

Those of skill in the art will recognize that the light source, power source, inner unit and lid may be configured in a variety of ways. For example, the power source and light source may be included in the inner unit. Alternatively, the power and light sources may be configured as part of the lid and the inner unit may be omitted. Many other permutations are possible.

The invention is useful as a novelty item. In a preferred embodiment, the device is approximately the size of an ice cube and may be used to illuminate a beverage by turning on the light source and placing the device in the beverage. The invention may also be used for other purposes such as playing games or decorating, either in a wet or dry environment.

While there have been described what are believed to be preferred embodiments of the present invention, those skilled in the art will recognize that other and further changes and modifications can be made without departing from the spirit of the invention, and all such changes and modifications should be understood to fall within the scope of the invention.

What is claimed is:

1. An illuminable electronic device, comprising:
a transparent or translucent outer casing bounding a cavity, where the casing is generally cube-shaped and the outer edges are between about 25 and 35 mm in length;
a lid keeping the cavity watertight;
a light source within the cavity; and
a filler within the cavity; the filler being comprised of between about 25 and 200 plastic particles.

2. The device of claim 1, where the casing is essentially comprised of polypropylene.

3. The device of claim 2, where each wall of the casing has a faceted outwardly protuberant configuration.

4. The device of claim 1, further comprising an inner unit, where the inner unit supports the light source and is attached to a power source.

5. The device of claim 4, where the inner unit includes a printed circuit board.

6. The device of claim 4, where the lid includes a switch.

7. The device of claim 4, where the light is an LED.

8. The device of claim 1, where the particles are geometrically shaped.

9. The device of claim 8, where the particles are pyramid shaped.

10. The device of claim 9, where the particles are comprised of polypropylene.

11. The device of claim 9, where the device includes between about 75 and 125 particles.

12. The device of claim 11, where the particles weigh between about 0.07 and 0.13 grams each.
